(19) United States
(12) Patent Application Publication
(10) Pub. No.: US 2009/0313782 A1
(43) Pub. Date: Dec. 24, 2009

(54) WINDSHIELD WIPER

(75) Inventor: Ching-Chuan CHIEN, Taipei (TW)

Correspondence Address: PATENTTM.US, P. O. BOX 82788, PORTLAND, OR, 97282-0788, US

(73) Assignee: UNIPOINT ELECTRIC MFG. CO., LTD., Taipei (TW)

(21) Appl. No.: 12/143,602

(22) Filed: Jun. 20, 2008

(51) Int. Cl. B60S 1/38

(52) U.S. Cl. 15/250.31

(57) ABSTRACT

A windshield wiper has a rubber blade, an inner frame being mounted on the rubber blade, an beam being mounted on the inner frame, multiple clips being mounted respectively through the beam, multiple spoilers being mounted on the beam, two end caps being mounted respectively around the ends of the inner frame, the beam and the spoiler and a connector assembly being mounted securely on the beam and between two adjacent spoilers. The inner frame holds the rubber blade firmly. The clips hold the beam stably on the inner frame. Therefore, the rubber blade is connected firmly with other components of the windshield wiper, will not deform or deteriorate easily and has improved lifespan.

### BACKGROUND OF THE INVENTION

1. Field of the Invention

The present relates to a windshield wiper, especially to a windshield wiper that has a strengthened structure and will not deform or deteriorate easily so has improved life span.

2. Description of the Prior Arts

A windshield wiper is mounted on a windshield of a car and is pivoted back and forth over the windshield to wipe rain and dirt from the windshield to keep the windshield clean.

With reference to FIGS. 9 and 10, a conventional windshield wiper (90) comprises a rubber blade (91), two pads (92), four inner frames (93), two middle frames (94) and an outer frame (95).

The rubber blade (91) has a back surface, two opposite sidewalls, two clip recesses (911) and two pad recesses (912). The clip recesses (911) are formed respectively and oppositely in the sidewalls of the rubber blade (91). The pad recesses (912) are formed respectively and oppositely in the sidewalls of the rubber blade (91) between the back surface of the rubber blade (91) and the clip recesses (911).

The pads (92) are mounted respectively in the pad recesses (912) of the rubber blade (91) to support and strengthen the rubber blade (91).

The inner frames (93) are mounted respectively on the back surface of the rubber blade (91). Each inner frame (93) has two ends and two clips (931). The clips (931) are mounted respectively on the ends of the inner frame (93) and clip (931) respectively to the rubber blade (91) in the clip recesses (912) of the rubber blade (91).

The middle frames (94) are mounted respectively on the inner frames (93). Each middle frame (94) has two ends. The ends of the middle frame (94) are connected respectively to two adjacent inner frames (93).

The outer frame (95) is mounted on the middle frames (94) and has two ends. The ends of the outer frame (95) are connected respectively to the middle frames (94).

However, only the pads (92) being mounted in the pad recesses (911) of the rubber blade (91) strengthen a structure of the rubber blade (91) and the clips (931) of the inner frames (93) respectively hold the pads (92) to the rubber blade (91). The rubber blade (91) is delicate, deforms and deteriorates easily and has to be replaced frequently.

To overcome the shortcomings, the present invention provides a windshield wiper to mitigate or obviate the aforementioned problems.

### SUMMARY OF THE INVENTION

The main objective of the present invention is to provide a windshield wiper that has a rubber blade, an inner frame being mounted on the rubber blade, an beam being mounted on the inner frame, multiple clips being mounted respectively through the beam, multiple spoilers being mounted on the beam, two end caps being mounted respectively around the ends of the inner frame, the beam and the spoiler and a connector assembly being mounted securely on the beam and between two adjacent spoilers.

The inner frame entirely holds the rubber blade firmly. The clips hold the beam stably on the inner frame. Therefore, the rubber blade is connected firmly with other components of the windshield wiper, will not deform or deteriorate easily and has improved lifespan.

Other objectives, advantages and novel features of the invention will become more apparent from the following detailed description when taken in conjunction with the accompainying drawings.

### BRIEF DESCRIPTION OF THE DRAWINGS

FIG. 1 is a perspective view of a windshield wiper in accordance with the present invention;

FIG. 2 is an exploded perspective view of the windshield wiper in FIG. 1;

FIG. 3 is an end view in partial section of the windshield wiper in FIG. 1;

FIG. 4 is an enlarged perspective view of a first embodiment of a clip of the windshield wiper in FIG. 1;

FIG. 5 is an enlarged operational side view in partial section of the windshield wiper in FIG. 1, slowing the clip in FIG. 4 being mounted halfway on an beam of the windshield wiper;

FIG. 6 is an enlarged operational side view in partial section of the windshield wiper in FIG. 1, showing the clip in FIG. 4 being mounted securely on the beam of the windshield wiper;

FIG. 7 is an enlarged perspective view of a second embodiment of a clip of the windshield wiper in FIG. 1;

FIG. 8 is an enlarged operational side view in partial section of the windshield wiper in FIG. 1, showing the clip in FIG. 7 being mounted on the beam of the windshield wiper;

FIG. 9 is a perspective view of a conventional windshield wiper in accordance with the prior art; and

FIG. 10 is an end view-in partial section of the conventional windshield wiper in FIG. 9.

### DETAILED DESCRIPTION OF THE PREFERRED EMBODIMENTS

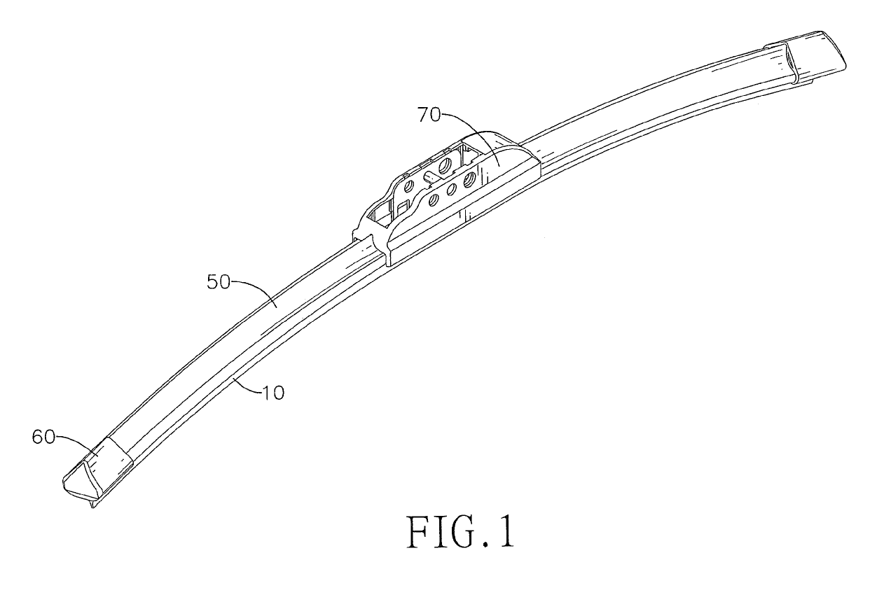

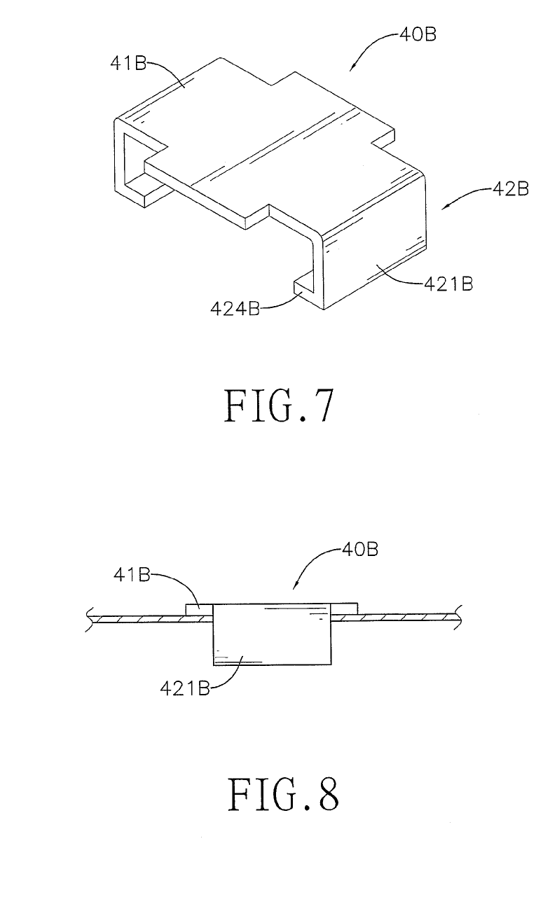

With reference to FIGS. 1, 2 and 7, a windshield wiper in accordance with the present invention comprises a rubber blade (10), an inner frame (20), an beam (30), multiple clips (40A, 40B), multiple spoilers (50), two end caps (60) and a connector assembly (70).

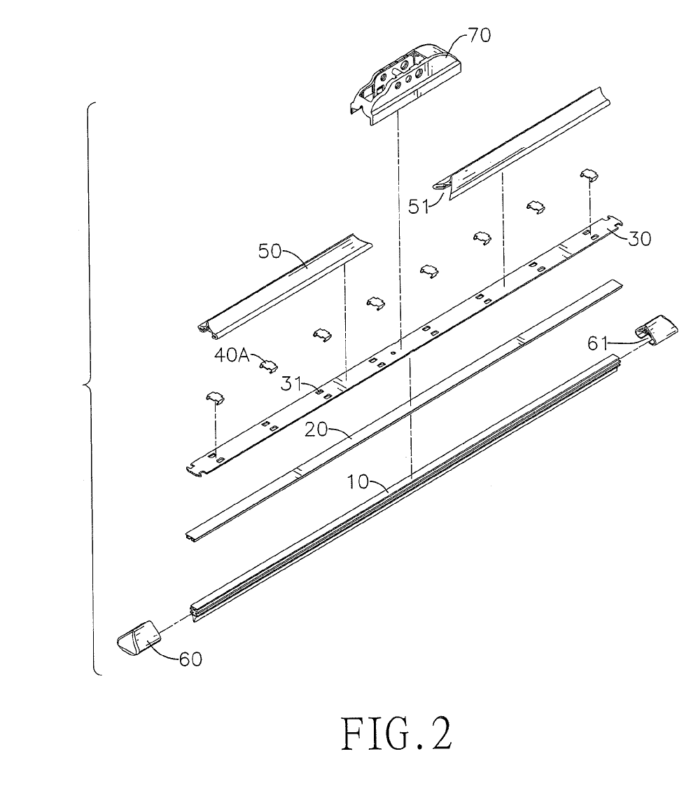

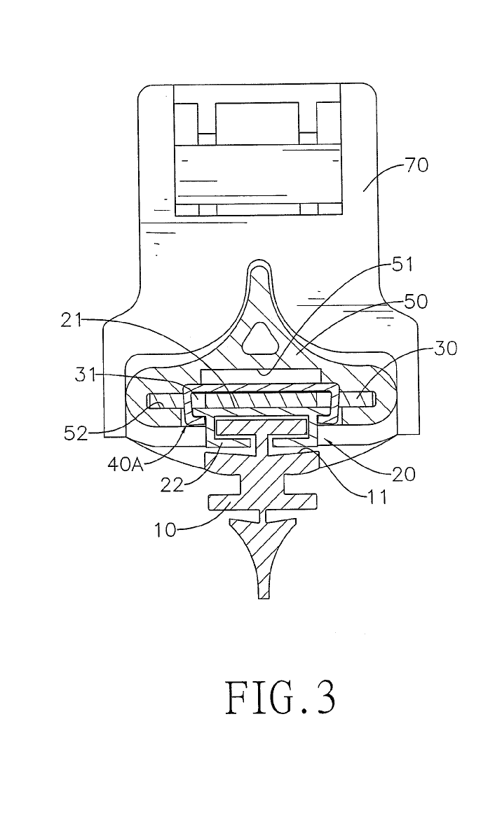

With reference to FIGS. 2 and 3, the rubber blade (10) has a back surface, two opposite sidewalls and two longitudinal mounting recesses (11). The longitudinal mounting recesses (11) are formed respectively and oppositely in the sidewalls of the rubber blade (10).

The inner frame (20) is mounted on the back surface of the rubber blade (10) and has two ends, a base (21) and two clipping protrusions (22). The base (21) is mounted on the back surface of the rubber blade (10) and has an inner surface, a back surface and two opposite longitudinal edges. The clipping protrusions (22) are formed on and protrude transversely from the inner surface of the base (20) near the longitudinal edges of the base (21) and respectively correspond to the longitudinal mounting recesses (11) of the rubber blade (10). Each clipping protrusion (22) is L-shaped in cross-section and is mounted respectively in the corresponding longitudinal mounting recess (11) of the rubber blade (10) to allow the inner frame (20) to hold and to support and strengthen the rubber blade (10).

The beam (30) is flat, is mounted on the back surface of the base (21) of the inner frame (20) and has a back surface, two opposite longitudinal edges, two ends and multiple pairs of through holes (31). Each pair of the through holes (31) are formed respectively through the beam (30) and near the longitudinal edges of the base (21) of the inner frame (20).

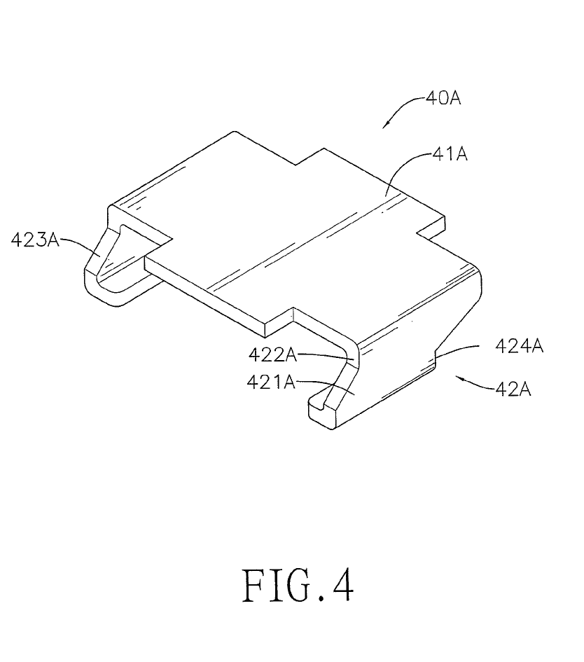

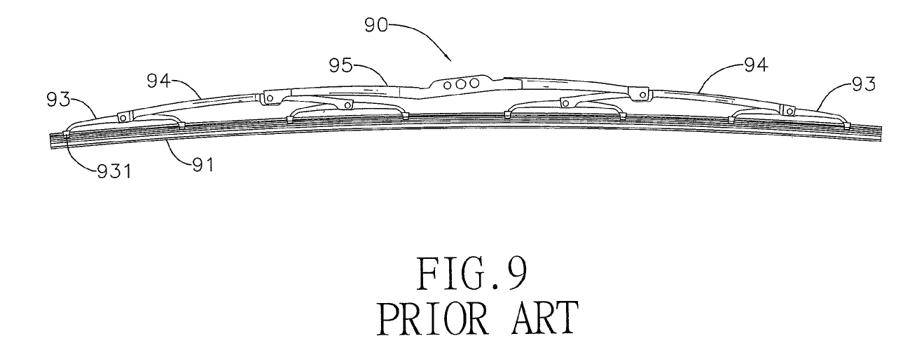

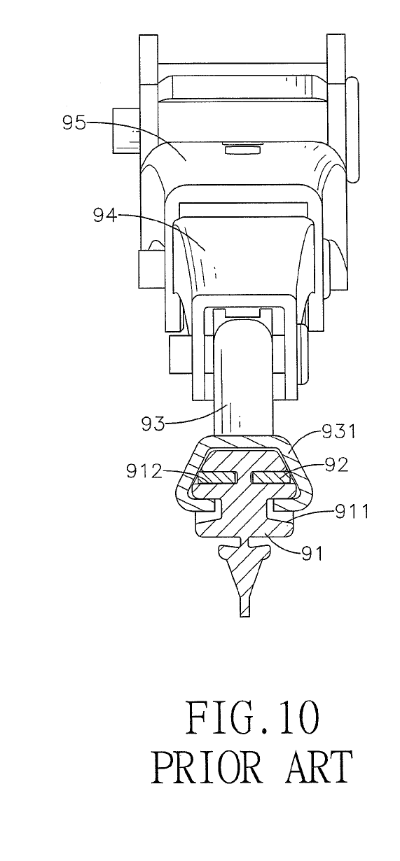

With further reference to FIGS. 4, 7 and 8, the clips (40A, 40B) are mounted on the back surface of the beam (30). Each clip (40A, 40B) corresponds to one pair of the through holes (31) of the beam (30) and has a base (41A, 41B) and two clipping protrusions (42A, 42B).

The base (41A, 41B) is mounted on the back surface of the beam (30) and has two opposite side edges.

The clipping protrusions (42A, 42B) are formed on and protrude respectively and transversely from the side edges of the base (41A, 41B) of the clip (40A, 40B), are L-shaped in cross-section, are mounted respectively through the corresponding pair of the through holes (31) of the beam (30) and respectively hold the longitudinal edges of the base (21) of the inner frame (20) to hold the beam (30) stably on the inner frame (20).

Each clipping protrusion on (42A, 42B) may have a connecting wall (421A, 421B) and a holding wall (424A, 424B). The connecting wall (421A, 421B) is formed on and protrudes transversely from the corresponding side edge of the base (41A, 42B) of the clip (40A, 40B), has a distal edge and may have two upright side edges (422A) and two inclined side edges (423A). The upright side edges (422A) are opposite to each other and are connected to the corresponding side edge of the base (41A). The inclined side edges (423A) are parallel with each other and are connected respectively to the upright side edges (422A). The holding wall (424A, 424B) is formed on and protrudes transversely from the corresponding distal edge of the connecting wall (421A, 421B), may be connected to the corresponding inclined side edges (423A) of the connecting wall (421A) and is mounted into the corresponding through hole (31) of the beam (30) to hold the longitudinal edges of the beam (30) and the corresponding longitudinal edge of the base (21) of the inner frame (20).

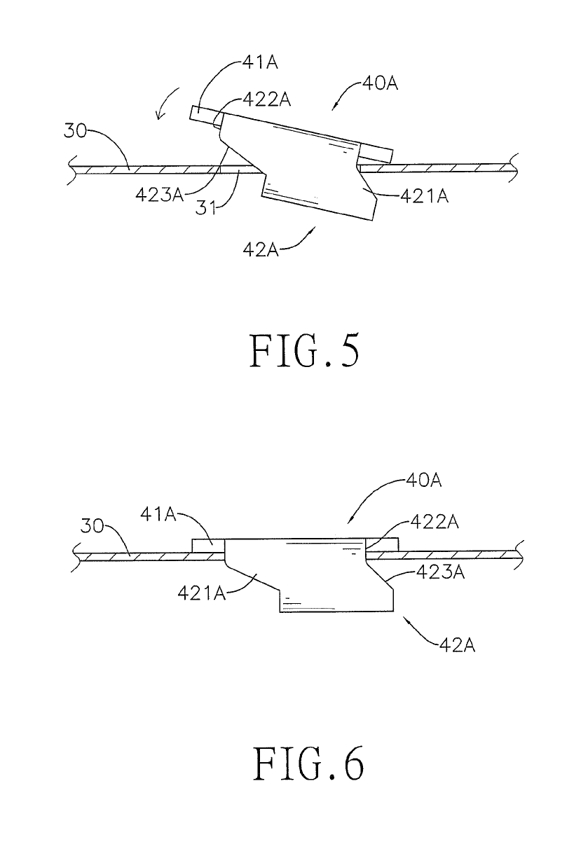

With further reference to FIGS. 5 and 6, when the clip (40A) is mounted into the through holes (31) of the beam (30), the clip (40A) should be slanted to allow the holding walls (424A) and the inclined side edges (423A) of the connecting walls (421A) of the clip (40A) to be mounted through the through holes (31) of the beam (30). Then, the clip (40A) is pushed to allow the upright side edges (422A) of the connecting walls (421A) of the clip (40A) to be mounted securely in the through holes (31) of the beam (30) and to allow the holding walls (424A) of the clip (40A) to hold the longitudinal edges of the beam (30). Therefore, the clip (40A) will not depart from the beam (30) easily.

The spoilers (50) are triangular in cross-section and are mounted respectively on the back surface of the beam (30) for aerodynamic stability while the windshield wiper is pivoted back and forth over a windshield of a car. Two of the spoilers (50) respectively correspond to the ends of the inner frame (20) and the beam (30). Each spoiler (50) has a bottom, a back surface, two ends, a mounting recess (51) and two positioning recesses (52). The mounting recess (51) is formed in the bottom of the spoiler (50) and has two opposite inner walls. The positioning recesses (52) are formed respectively in the inner walls of the mounting recess (51) of the spoiler (50) and are mounted respectively around the longitudinal edges of the beam (30) to hold the beam (30) and to allow the spoilers (50) to be mounted stably on the back surface of the beam (30).

The end caps (60) are mounted respectively on the ends of the spoilers (50) that correspond to the ends of the inner frame (20) and the beam (30) and are mounted around the ends of the rubber blade (10), the inner frame (20) and the beam (30) to ornament and protect the ends of the rubber blade (10), the inner frame (20), the beam (30) and the spoilers (50). Each end cap (60) has an outer end, an inner end, a bottom and a mounting recess (61). The outer end of the end cap (60) is closed. The mounting recess (61) is formed in the inner end of the end cap (60) and through the bottom of the end cap (60) and is mounted on the corresponding ends of the spoilers (50) and around the ends of the rubber blade (10), the inner frame (20) and the beam (30).

The connector assembly (70) is mounted securely on the back surface of the beam (30) and between two adjacent spoilers (50), is connected pivotally to one end of an arm that is connected to the car to allow the arm sweep the windshield wiper back and forth over the windshield of the car and has two ends and two mounting recesses (71). The mounting recesses (71) are respectively formed in the ends of the connector assembly (70). Each mounting recess (70) corresponds to and is mounted around the back surface of the adjacent spoiler (50).

The windshield wiper as described has the following advantages. The clipping protrusions (22) of the inner frame (20) holds the rubber blade (10) firmly. The clips (40A, 40B) hold the beam (30) stably on the inner frame (20). Therefore, the rubber blade (10) is connected firmly with other components of the windshield wiper, will not deform or deteriorate easily and has an improved life span.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A windshield wiper comprising
a rubber blade having two longitudinal mounting recesses being formed respectively and oppositely in two opposite sidewalls of the rubber blade;
an inner frame being mounted on a back surface of the rubber blade and having
two ends;
a base being mounted on the back surface of the rubber blade; and
two clipping protrusions being formed respectively on and protruding transversely from an inner surface of the base and respectively corresponding to and being mounted in the longitudinal mounting recesses of the rubber blade;
a beam being mounted on a back surface of the base of the inner frame and having
two ends; and
multiple pairs of through holes, and each pair of the through holes being formed respectively through the beam;
multiple clips being mounted on the back surface of the beam, and each clip corresponding to one pair of the through holes of the beam and having
a base being mounted on the back surface of the beam; and
two clipping protrusions being formed on and protruding respectively and transversely from the base of the clip, being mounted respectively through the corresponding pair of the through holes of the beam, respectively holding two opposite longitudinal edges of the base of the inner frame and each clipping protrusion having
a connecting wall being formed on and protruding transversely from the base of the clip; and
a holding wall being formed on and protruding transversely from the connecting wall and holding a corresponding longitudinal edge of the base of the inner frame;
multiple spoilers being mounted respectively on the back surface of the beam, two of the spoilers respectively corresponding to the ends of the inner frame and the beam, and each spoiler having two ends;
two end caps being mounted respectively on the ends of the spoilers that corresponding to the ends of the inner frame and the beam and being mounted around the ends of the rubber blade, the inner frame and the beam; and
a connector assembly being mounted securely on the back surface of the beam and between two adjacent spoilers.

2. The windshield wiper as claimed in claim 1, wherein
each spoiler further has
a mounting recess being formed in a bottom of the spoiler; and
two positioning recesses being formed respectively in two opposite inner walls of the mounting recess of the spoiler and being mounted respectively around two opposite longitudinal edges of the beam;
each end cap has
an outer end being closed; and
a mounting recess being formed in an inner end of the end cap and through a bottom of the end cap and being mounted on the corresponding ends of the spoilers and around the ends of the rubber blade, the inner frame and the beam; and
the connector assembly further has
two ends; and
two mounting recesses being respectively formed in the ends of the connector assembly and each mounting recess corresponding to and being mounted around a back surface of the adjacent spoiler.

3. The windshield wiper as claimed in claim 1, wherein
the clipping protrusions of the inner frame and the clipping protrusions of the clips are L-shaped in cross-section;
the beam is flat; and
the spoilers are triangular in cross-section.

4. The windshield wiper as claimed in claim 2, wherein
the clipping protrusions of the inner frame and the clipping protrusions of the clips are L-shaped in cross-section;
the beam is flat; and
the spoilers are triangular in cross-section.

5. A windshield wiper comprising
a rubber blade having two longitudinal mounting recesses being formed respectively and oppositely in two opposite sidewalls of the rubber blade;
an inner frame being mounted on a back surface of the rubber blade and having
two ends;
a base being mounted on the back surface of the rubber blade; and
two clipping protrusions being formed respectively on and protruding transversely from an inner surface of the base and respectively corresponding to and being mounted in the longitudinal mounting recesses of the rubber blade;
a beam being mounted on a back surface of the base of the inner frame and having
two ends; and
multiple pairs of through holes, and each pair of the through holes being formed respectively through the beam;
multiple clips being mounted on a back surface of the beam, and each clip corresponding to one pair of the through holes of the beam and having
a base being mounted on the back surface of the beam; and
two clipping protrusions being formed on and protruding respectively and transversely from the base of the clip, being mounted respectively through the corresponding pair of the through holes of the beam, respectively holding two opposite longitudinal edges of the base of the inner frame and each clipping protrusion having
a connecting wall being formed on and protruding transversely from the base of the clip and having
two upright side edges being opposite to each other and being connected to the base of the clip; and
two inclined side edges being parallel with each other and being connected respectively to the upright side edges; and
a holding wall being formed on and protruding transversely from the connecting wall, being connected to the inclined side edges of a corresponding connecting wall and holding a corresponding longitudinal edge of the base of the inner frame;
multiple spoilers being mounted respectively on the back surface of the beam, two of the spoilers respectively corresponding to the ends of the inner frame and the beam, and each spoiler having two ends;
two end caps being mounted respectively on the ends of the spoilers that corresponding to the ends of the inner frame and the beam and being mounted around the ends of the rubber blade, the inner frame and the beam; and
a connector assembly being mounted securely on the back surface of the beam and between two adjacent spoilers.

6. The windshield wiper as claimed in claim 5, wherein
each spoiler further has
a mounting recess being formed in a bottom of the spoiler; and
two positioning recesses being formed respectively in two opposite inner walls of the mounting recess of the spoiler and being mounted respectively around two opposite longitudinal edges of the beam;
each end cap has
an outer end being closed; and
a mounting recess being formed in an inner end of the end cap and through a bottom of the end cap and being mounted on the corresponding ends of the spoilers and around the ends of the rubber blade, the inner frame and the beam; and
the connector assembly further has
two ends; and
two mounting recesses being respectively formed in the ends of the connector assembly and each mounting recess corresponding to and being mounted around a back surface of the adjacent spoiler.

7. The windshield wiper as claimed in claim 5, wherein
the clipping protrusions of the inner frame and the clipping protrusions of the clips are L-shaped in cross-section;
the beam is flat; and
the spoilers are triangular in cross-section.

8. The windshield wiper as claimed in claim 6, wherein
the clipping protrusions of the inner frame and the clipping protrusions of the clips are L-shaped in cross-section;
the beam is flat; and
the spoilers are triangular in cross-section.
